(19) United States
(12) Patent Application Publication
(10) Pub. No.: US 2017/0240428 A1
(43) Pub. Date: Aug. 24, 2017

(54) TWO-DIMENSIONAL MATERIALS

(71) Applicant: Thomas Swan & Co. Ltd, Consett (GB)

(72) Inventors: Paul Ladislaus, Consett (GB); Keith Paton, Consett (GB); Ronan McHale, Consett (GB)

(21) Appl. No.: 15/511,459

(22) PCT Filed: Sep. 14, 2015
(86) PCT No.: PCT/GB2015/052657

§ 371 Date: Mar. 15, 2017

(30) Foreign Application Priority Data
Sep. 16, 2014 (GB) 1416317.4

(51) Int. Cl. C01B 31/02; B01D 61/00; C01B 21/064; B01D 65/02; C01B 31/04

(52) U.S. Cl. CPC C01B 31/0492; C01B 21/0648; B01D 61/00; B01D 65/02; B01D 2321/16; B01D 2325/02

(57) ABSTRACT

A method of preparing a 2D material (e.g. graphene or of boron nitride), the method comprising: (i) selecting a fluid comprising the 2D material dispersed in a solvent; (ii) using a filtration device to remove solvent from the fluid and increase the concentration of 2D material in the fluid, wherein the fluid suitably includes a surfactant, which may be sodium cholate or sodium dodecylbenezenesulphonate and wherein the filtration device is suitably a cross-flow filtration device.

This invention relates to two-dimensional materials as described and provides methods relating to such materials. Preferred embodiments relate to graphene.

A wide range of two-dimensional (2-D) atomic crystals exist in nature. The simplest is graphene (an atomic-scale 2-D honeycomb lattice of carbon atoms), followed by boron nitride (BN). However, others exist including transition metal dichalcogenides (TMDs) such as molybdenum disulphide ((MoS₂), niobium diselenide (NbSe2), tungsten diselenide (WSe₂), tungsten disulphide (WS₂), vanadium telluride (VTe2), transmission metal oxides such as manganese dioxide (MnO₂), molybdenum trioxide (MoO₃) and other layered compounds such as bismuth telluride (Bi2Te3).

A reference to 2-D materials herein includes materials which comprise monolayers (e.g. planes of one atom thick) or multiple layers comprising multiple planes (e.g. up to 30 layers) bonded together by weak non-covalent bonds. Such 2-D materials may have a thickness up to 20 nm.

There have been many proposals for producing 2-D materials from layered materials such as graphite.

One known method of producing graphene by exfoliation involves oxidation of graphite to create graphite oxide wherein oxygen atoms are covalently bound to the graphene carbon atoms. This swells the graphite, weakening the binding energy between graphene layers. It also allows water to intercalate between the layers which further weakens the binding, ultimately allowing exfoliation. The oxide groups can subsequently be removed by reduction either chemically or thermally. One problem in the method is that the graphene produced contains many defects. For example, it always contains missing atoms or even holes in the nanosheets which severely distort its mechanical and electrical properties to the extent that it cannot be considered graphene but only graphene-like. Thus, oxidisation cannot be used to develop a simple scalable method to produce defect free graphene.

Another method, based on intercalation of species such as ions between layers has been widely applied to exfoliate layered materials including graphite and MoS₂. Intercalation increases the layer spacing, weakening the interlayer adhesion, and reducing the energy barrier to exfoliation. Intercalants such as n-butyllithium or IBr can transfer charge to the layers, resulting in a further reduction of interlayer binding. Subsequent treatment such as thermal shock or ultrasonication in a liquid completes the exfoliation process. The exfoliated nanosheets can be stabilised electrostatically by a surface charge or by surfactant addition. In the case of MoS₂, this method tends to give highly exfoliated nanosheets but has drawbacks associated with its sensitivity to ambient conditions. However, a very significant disadvantage is that the process contains multiple steps (intercalation followed by exfoliation) and cannot be used to develop a simple, scalable method to produce defect free graphene (or other 2D materials).

Another method involves the ultrasonication of a layered material such as graphite or MoS₂ in a suitable solvent or aqueous surfactant solution. Here the high level of ultrasonic power (˜300 W) being dissipated in a small volume of liquid (˜100 ml) results in a very high power density (˜3000 W/L). The energy dissipated acts to break up the crystal into individual nanosheets. However, this process cannot give true exfoliation unless the nanosheets are stabilised against reaggregation. This is achieved either by choosing special solvents which stabilise the exfoliated nanosheets by interacting with their surface or by sonicating in a water-surfactant or water-polymer mixture. The surfactant molecules (or ions in some cases) or polymer chains stick to the nanosheets surface stabilising them against reaggregation.

However, an ongoing general challenge is to produce, on an industrial scale, 2D materials such as graphene which is of high quality and includes low levels of contaminants. It is an object of the invention to address this general problem.

As described above, it is known to use a surfactant in an exfoliation step in the production of graphene. However, the presence of high levels of surfactant in a graphene product may, in some cases, (e.g. conductive composites, conductive inks, electrodes including battery anodes and cathodes and capacitor electrodes) be disadvantageous. Thus, it is an object of a preferred embodiment of the invention to provide a process for producing a 2D material, for example graphene, with a lower level of surfactant contamination.

In some cases, a graphene product may be in the form of a graphene dispersion. It is desirable to be able to produce such a dispersion efficiently, at a predetermined concentration, on a commercial scale. It is an object of a preferred embodiment of the invention to address this problem.

According to a first aspect of the invention, there is provided a method of preparing a 2D material, the method comprising:
(i) selecting a fluid comprising a 2D material dispersed in a solvent;
(ii) using a filtration device to remove solvent from the fluid and increase the concentration of 2D material in the fluid;

wherein said filtration device comprises an inlet for passage of fluid into the filtration device and an outlet for passage of unfiltered fluid away from the filtration device, wherein a filtration surface is positioned between the inlet and outlet and the filtration device is arranged to direct fluid tangentially or parallel to the filtration surface.

Although there is much prior art on, for example, graphene production, for example using exfoliation processes, there have been few, if any, practical proposals for concentrating and/or isolating graphene on a commercial scale. The present invention advantageously provides a commercially relevant process which is scaleable and is able to produce graphene relatively quickly and economically.

Said 2D material may be as described in the introduction of the present specification. Preferably, said 2D material described herein has, on average, fewer than 20 or more, preferably, fewer than 10 layers. Preferably, the average thickness of such 2D material described herein is less than 10 nm

In the method, at least 10 litres, for example at least 30 litres, of fluid may be selected in step (i). Said fluid may be contained in a receptacle having a volume of at least 15 litres.

Said device suitably includes a conduit for passage of filtrate (i.e. fluid which is small enough to pass through openings defined in the filtration surface) away from the filtration surface. Said filtration surface is suitably arranged so that at least 80 wt %, preferably at least 95 wt %, especially about 100 wt % of said 2D material included in said fluid selected in step (i) does not pass through said filtration surface. Thus, said filtrate preferably includes less than 1 wt %, or less than 0.1 wt % or, especially, substantially 0 wt % of said 2D material. Thus, the 2D material prepared is suitably collected downstream of said outlet via which unfiltered fluid passes away from the filtration device.

Said inlet and said outlet are suitably on the same side of the filtration surface and said conduit for passage of filtrate away is on an opposite side of the filtration surface.

Said filtration surface preferably has a pore size (preferably over substantially its entire extent) of less than 1000 kDa, preferably less than 750 kDa. The pore size may be at least 200 kDa.

Said filtration device preferably includes an elongate conduit (e.g. tube) having an inlet and outlet as described where a wall (e.g. a cylindrical wall) of the conduit defines said filtration surface. A lumen defined by the wall may have a diameter of at least 0.1 mm, for example at least 0.5 mm; the diameter may be less than 5 mm or less than 2 mm. Said conduit may have a length of at least 50 cm; and the length may be less than 150 cm.

Said filtration device may include a plurality, for example at least 10, preferably at least 40 of said conduits. Each conduit suitably includes an inlet for passage of fluid into the filtration device and an outlet for passage of unfiltered fluid away from the filtration device and a said filtration surface as described. In said filtration device, the total area defined by the filtration surfaces of said conduits may be at least 500 cm², for example at least 750 cm². It may be less than 10000 cm² or less than 2000 cm².

In the method, the pressure of fluid at the inlet of the filtration device may be in the range 200,000 to 300,000 Pa. The pressure of fluid at the outlet for passage of unfiltered fluid away from the filtration device may be in the range 100,000 to 150,000 Pa. The pressure on the filtrate side of the filtration surface may be ambient pressure. In the method the pressure across the filtration surface of the device may be in the range 50,000 to 200,000 Pa.

In the method the rate of flow of fluid comprising said 2D material dispersed in said solvent into the filtration device may be at least 300 litres/hour; and may be less than 800 litres/hour.

Said filtration device is preferably a cross-flow filtration device.

Said fluid selected in step (i) may include a single type of 2D material. Said 2D material may be selected from graphene and 2D boron nitride, molybdenum disulphide, niobium diselenide, tungsten diselenide, tungsten disulphide, vanadium telluride, manganese oxide and molybdenum trioxide. Said 2D material is preferably selected from graphene and 2D boron nitride. In especially preferred embodiments, said fluid selected in step (i) includes graphene and, preferably, the only 2D material in said fluid is graphene.

Said fluid selected in step (i) preferably includes a surfactant. Suitably, the surfactant is added to a formulation comprising a 3D material, for example graphite, upstream of method step (i) to facilitate exfoliation of the 3D material as described herein. Said surfactant is preferably water soluble. It may have a solubility in water of at least 10 g/L, suitably at least 100 g/L, preferably at least 140 g/L at 20° C. Preferably, at the concentration and temperature of said fluid selected in step (i), said surfactant is fully soluble and is fully solubilised in water. Said surfactant may have a molecular weight of less than 800, preferably less than 600, more preferably less than 500. The molecular weight may be greater than 300. Said surfactant preferably includes hydroxy functional groups and suitably includes at least 2, preferably at least 3 hydroxy groups. It may include less than 10 or less than 5 hydroxy groups. Said surfactant preferably includes a moiety —COO⁻ (i.e. an acetate moiety). It preferably includes at least one —COO⁻ moiety; it may include less than 3, preferably less than 2 acetate moieties. Said surfactant is preferably saturated. It is preferably cyclic. It preferably includes fused rings, for example fused saturated hydrocarbon rings. Said surfactant preferably does not include any sulphur atoms. Said surfactant preferably does not include any nitrogen atoms. Said surfactant may be an ionic surfactant. Preferably, other than an optionally included counterion of said surfactant, said surfactant includes no atoms other than carbon, hydrogen and oxygen atoms. Preferably, said surfactant include a moiety which includes carbon, hydrogen and oxygen atoms only and an optional second moiety which is a counterion. Said surfactant is preferably ionic and, more preferably, is anionic. Said surfactant may include a cation having a molecular weight of less than 50, for example less than 40.

Said surfactant may be selected from sodium cholate, sodium dodecylsulphate, sodium dodecylbenzenesulphonate, lithium dodecyl sulphate, deoxycholate, taurodeoxycholate, polyoxyethylene (40) nonylphenyl ether, branched (IGEPAL CO-890® (IGP)), polyethylene glycol p-(1,1,3,3-tetramethylbutyl)-phenyl ether (Triton-X 100® (TX-100)). Said surfactant is preferably an ionic surfactant with anionic surfactants being preferred.

Said surfactant is preferably a cholate. Sodium cholate is especially preferred.

The use of said cholate may be preferred since it has been found to be possible to destabilise and dry a graphene dispersion containing cholate by adding a small amount of sulphuric acid (e.g. concentrated sulphuric acid) to drop out the graphene powder. Thus, preferably, subsequent to step (i), the method may comprise contacting a graphene dispersion with a reagent (e.g. sulphuric acid) to drop out the graphene powder.

Another preferred surfactant is a benzenesulphonate for example sodium dodecylbenzenesulphonate.

Said solvent is preferably water. At least 90 wt %, preferably at least 99 wt % of solvent present in said fluid is water.

Said fluid selected in step (i) may also include a 3D material from which the 2D material is derived or derivable. For example, when said fluid includes graphene, said fluid may also include some residual graphite.

Said fluid selected in step (i) suitably includes at least 0.02 g/L, for example at least 0.05 g/L of said 2D material, for example graphene; it may include less than 0.5 g/L or less than 0.2 g/L of said 2D material, for example graphene.

Said fluid selected in step (i) suitably includes at least 0.01 g/L, for example at least 0.05 g/L of 3D material from which the 2D material is derived or derivable; it may include less than 0.5 g/L of said 3D material.

Said fluid selected in step (i) suitably includes at least 0.2 g/L, for example at least 0.7 g/L of said surfactant, for example sodium cholate; it may include less than 2 g/L, for example less than 1.2 g/L of said surfactant.

Said fluid selected in step (i) may have a bulk conductivity at 20° C. of at least 50 μS/cm, for example at least 100 μS/cm; the conductivity may be less than 350 μS/cm.

In said fluid selected in step (i), the ratio of the concentration of 2D material divided by the concentration of surfactant may be in the range 0.025 to 2, for example 0.04 to 0.2.

Advantageously, the method may be used to increase the concentration of 2D material, for example graphene, in said solvent. Thus, during the method, the ratio of the concentration of 2D material in the unfiltered fluid at said outlet divided by the concentration of 2D material selected in step (i) may be at least 10, preferably at least 20. It may be less than 50.

Advantageously, the method may be used to reduce the concentration of surfactant in the unfiltered fluid at said outlet compared to the concentration of surfactant in the fluid selected in step (i). To facilitate this, the method may include a wash step wherein unfiltered fluid from said outlet is diluted with additional solvent (e.g. water) and the diluted unfiltered fluid is reintroduced into the filtration device via its inlet. It is then filtered for a second time in step (ii). Dilution as described may comprise adding a volume of solvent (e.g. water) which represents at least 50%, for example at least 80%, of the volume of the unfiltered fluid from said outlet which is diluted by said solvent.

After step (ii), suitably after dilution as described, the concentration of surfactant in said solvent may be less than 0.5 g/L, preferably less than 0.1 g/L, for example less than 0.06 g/L. The concentration (e.g. of sodium cholate) may be at least 0.01 g/L.

The ratio of the concentration of surfactant at the beginning of the method (e.g. the fluid initially selected in step (i)) divided by the concentration of surfactant in the unfiltered fluid in said outlet, suitably after one or more wash steps as described, may be at least 15, for example at least 20. It may be less than 50.

Prior to step (i), the method may include a step (A) which comprises selecting a 3D material and treating the 3D material to exfoliate it and produce said 2D material. Step (A) may comprise selecting a liquid formulation (A) comprising said 3D material (which may be as described above and, preferably, is graphite), said surfactant (which may be as described above and, preferably, is sodium cholate) and said solvent (which is preferably water).

Said liquid formulation (A) may be subjected to a shear force to exfoliate the 3D material. Said shear force may generate a shear rate of greater than 5,000 s⁻¹, preferably greater than 10,000 s⁻¹, more preferably greater than 30,000 s⁻¹. The shear rate may be less than 100,000 s⁻¹ or less than 70,000 s⁻¹.

Suitably, to apply said shear force, liquid formulation (A) is introduced into a shear mixer (e.g. a rotor/stator shear mixer). The mixer may rotate at greater than 2500 rpm. Batches of liquid formulation (A) may be treated.

Liquid formulation (A) may include 2000 to 4000 parts by weight (pbw) 3D material (e.g. graphite), 20000 to 40000 pbw of solvent (e.g. water) and 10 to 100 pbw of said surfactant (e.g. cholate). It has been discovered that, advantageously, the level of surfactant (especially sodium cholate when graphite is being exfoliated) may be reduced from the levels hitherto used in practice. Thus, in a preferred embodiment, the ratio of the wt % of 3D material (e.g. graphite) divided by the wt % of surfactant (e.g. sodium cholate) may be less than 350, and preferably is less than 325. The ratio may be at least 100 or at least 200.

In step (A), exfoliation may be undertaken for at least 4 hours and preferably less than 12 hours.

After exfoliation in step (A), a liquid formulation (B) may result which includes 80 to 120 pbw of said 3D material (e.g. graphite), 0.2 to 1.2 pbw of said 2D material (e.g. graphene) and 0.5 to 2 pbw of said surfactant (e.g. sodium cholate).

In some known exfoliation processes, the starting 3D material (e.g. graphite) is treated prior to exfoliation in order to facilitate the exfoliation process. For example, it is known to oxidize the 3D material (e.g. graphite to produce an oxidized graphite) or to intercalate species such as ions between layers of the 3D material. Such methods, however, are disadvantageous—e.g. they involve a further initial process step; and in the case of oxidization, the exfoliated 3D material needs to be reduced subsequently (or disadvantageously may be used in an oxidized state). In the case of use of ions, such ions represent a contaminant which adds to the complexity of downstream processes and/or may contaminate the final product.

The present method allows 2D material to be produced without the need for oxidization or ionic intercalation as aforesaid. Thus, preferably, the 3D material (e.g. graphite) in liquid formulation (A) includes less than 5 wt % (preferably less than 1 wt %, especially about 0 wt %) of oxidized 3D material (e.g. graphite oxide); and/or preferably the 3D material (e.g. graphite) in said liquid formulation (A) includes less than 1 wt % especially about 0 wt %) of ionic species which are not naturally occurring in the 3D material and which are intercalated between layers of the 3D material. In a preferred embodiment, said 3D material is graphite and at least 99 wt %, preferably at least 99.9 wt % of said graphite is non-oxidized; and/or at least 99 wt %, preferably 99.9 wt %, is non intercalated by ionic materials which are not naturally occurring in the graphite.

Liquid formulation (B) produced after exfoliation in step (A) may be treated in a step (B) to remove the 3D material from liquid formulation (B) and increase the concentration of 2D material relative to 3D material. Treatment of liquid formulation (B) in step (B) may comprise filtration and/or use of a hydrocyclone. The ratio of the wt % of said 3D material before step (B) divided by the wt % of said 3D material after step (B) may be greater than 300 or greater than 450.

Preferably, 3D material removed in step (B) is recycled back into step (A).

Preferably, at least part of the filtrate produced in step (ii) of the method (e.g. comprising surfactant as described) is recycled back into step (A).

Subsequent to step (ii) of the method, the unfiltered fluid (which is suitably relatively concentrated in said 2D material) is further treated to remove the 3D material (e.g. graphite) and increase the ratio of the wt % of 2D material divided by the wt % of 3D material in the product. Treatment may comprise centrifugation. Suitably, 3D material separated from the 2D material is recycled back into step (A). The 2D material may define a formulation of 2D material (e.g. a graphene formulation) having a conductivity at 20° C. of 1 to 5 μS/cm.

Said formulation of 2D material may have less than 0.1 wt %, preferably less than 0.05 wt %, especially less than 0.02 wt % of inorganic residues.

According to a second aspect of the invention, there is provided a method of reducing the level of surfactant in a fluid which comprises a 2D material (especially graphene), the method comprising:
(i) selecting a fluid comprising said surfactant and said 2D material (especially graphene) dispersed in a solvent;
(ii) using a filtration device to remove solvent including said surfactant from the fluid;

wherein said filtration device comprises an inlet for passage of fluid into the filtration device and an outlet for passage of unfiltered fluid away from the filtration device, wherein a filtration surface is positioned between the inlet and outlet and the filtration device is arranged to direct fluid tangentially or parallel to the filtration surface.

In the method, at least 10 litres, for example at least 30 litres of fluid may be selected. Said fluid may be contained in a receptacle having a volume of at least 15 litres.

Said filtration device is preferably as described in the first aspect. Thus, said device suitably includes a conduit for passage of filtrate away from the filtration surface. Said filtration surface may be as described according to the first aspect. The pressure of fluid at the inlet and outlet of the filtration device may be as described in the first aspect. The pressure on the filtrate side of the filtration device may be as described in the first aspect.

Preferably, said fluid is as described according to the first aspect. Said surfactant is suitably as described according to the first aspect. Said 2D material is preferably as described according to the first aspect. Said surfactant is suitably as described according to the first aspect.

In step (ii) of the method of the second aspect, solvent including said surfactant suitably passes through the filtration surface and suitably defines the filtrate produced using the filtration device. Thus, suitably the weight of surfactant in the fluid which passes into the filtration device is reduced as it passes from the inlet to outlet and such surfactant is incorporated into the filtrate produced. Suitably, at least 10%, preferably at least 30%, more preferably at least 50% of the weight of surfactant in said fluid which passes into the filtration device is removed from said fluid and is incorporated into filtrate produced.

The invention, in a third aspect, extends to a method of increasing the concentration of graphene in a fluid, the method comprising:
(i) selecting a fluid comprising a 2D material dispersed in a solvent;
(ii) using a filtration device to remove solvent from the fluid and increase the concentration of 2D material in the fluid;

wherein said filtration device comprises an inlet for passage of fluid into the filtration device and an outlet for passage of unfiltered fluid away from the filtration device, wherein a filtration surface is positioned between the inlet and outlet and the filtration device is arranged to direct fluid tangentially or parallel to the filtration surface.

The invention of the third aspect may include any feature of the invention of the first aspect. For example, preferably, said fluid is as described according to the first aspect. Said surfactant is suitably as described according to the first aspect. Said 2D material is preferably as described according to the first aspect. Said surfactant is suitably as described according to the first aspect.

According to a fourth aspect, there is provided a 2D material prepared as described in the first aspect.

According to a fifth aspect, there is provided a fluid with reduced level of surfactant prepared as described in the second aspect.

According to a sixth aspect, there is provided a 2D material prepared as described in the third aspect.

According to a seventh aspect of the invention, there is provided a graphene formulation, the graphene formulation comprising graphene, suitably being a 2D material as described herein, and residual surfactant, wherein said surfactant is suitably an anionic surfactant (and is preferably a cholate, for example sodium cholate), wherein the ratio of the wt % of said surfactant divided by said graphene in said formulation is less than 0.04, preferably less than 0.03. The ratio may be at least 0.0006, for example, at least 0.006.

Said formulation may have a D/G of 0.5 or less.

Said formulation may include a bulk conductivity of 1 to 10 μS/cm, for example 2-6 μS/cm.

Said formulation may include at least 1 g/L, preferably at least 1.5 g/L of graphene. It may include less than 5 g/L graphene. Said formulation may include less than 0.1 g/L, preferably less than 0.08 g/L, especially less than 0.05 g/L of surfactant as described in any statement herein. It may include at least 0.001 g/L of said surfactant.

The volume of said graphene formulation may be at least 1 litre, for example at least 5 litres.

Preferably, said graphene particles in said formulation have, on average, fewer than 20 or fewer than 10 layers.

As described in the first aspect, and in Example 4 hereinafter, it has been discovered that the level of surfactant may be reduced in a liquid formulation (liquid formulation (A) of the final aspect) to optimise the rate of exfoliation. Thus, the invention extends to a liquid formulation (A) for use in an exfoliation process described. In an eighth aspect, the invention extends to a liquid formulation (A) per se. Liquid formulation (A) may include 2000 to 4000 parts by weight (pbw) 3D material (e.g. graphite), 20000 to 40000 pbw of solvent (e.g. water) and 10 to 100 pbw of said surfactant (e.g. cholate).

Said 3D material in liquid formulation (A) is preferably graphite and the ratio of the wt % of said graphite divided by the wt % of said surfactant (being as described according to the first aspect and preferably being a cholate) is less than 350, preferably less than 325. The ratio may be at least 100 or at least 200.

The 2D material described herein may have numerous uses. Liquid formulations of 2D material described herein may be selected and, after optional further treatments, may be used, for example in preparation of conductive materials, for example conductive films or in capacitors.

Any invention described herein may be combined with any feature of any other invention described herein mutatis mutandis.

Specific embodiments of the invention will now be described, by way of example, with reference to the accompanying drawings, in which:

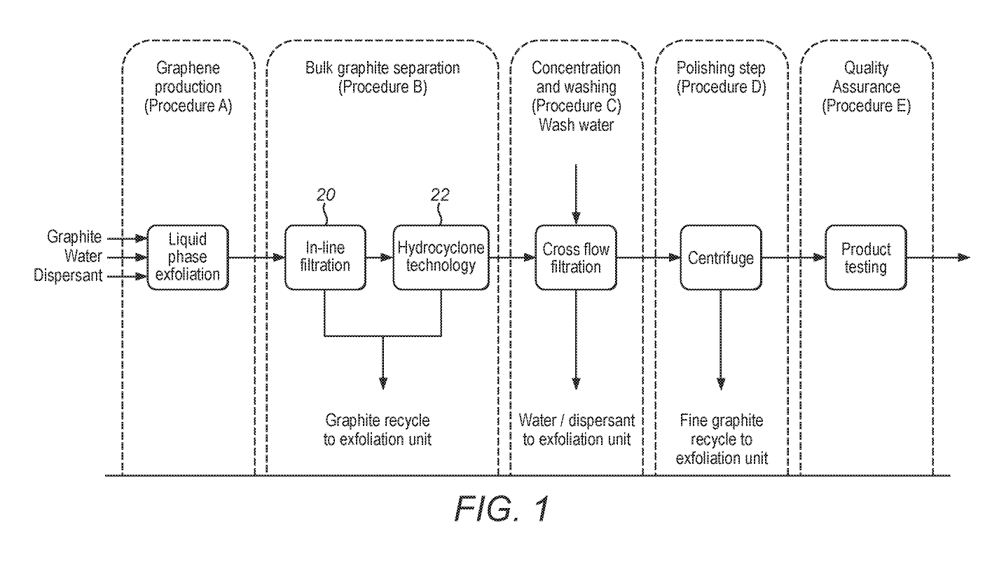

FIG. 1 is a schematic of a graphene production process;

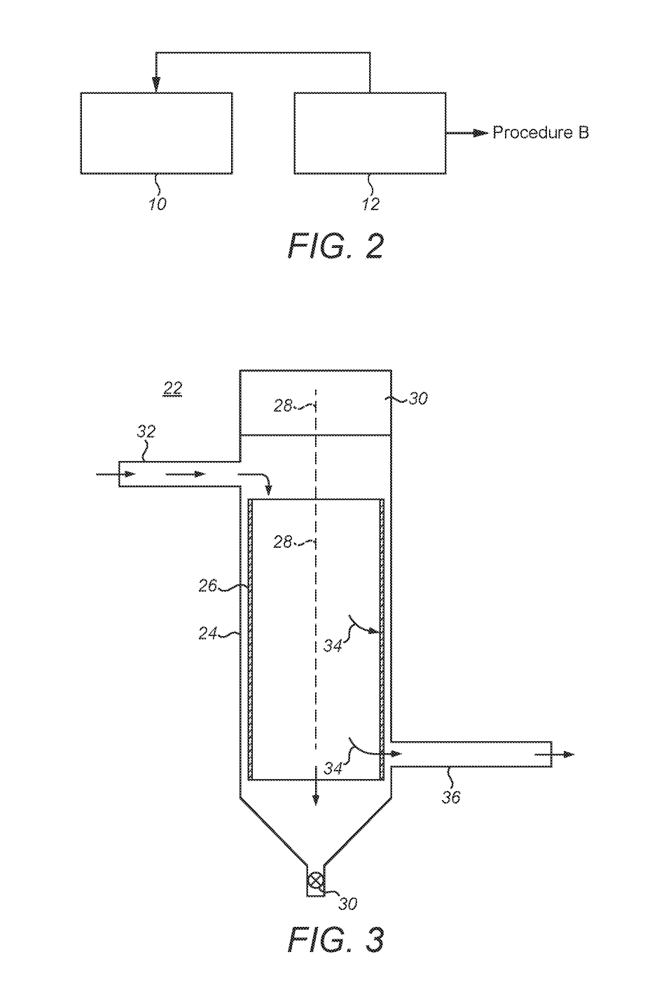

FIG. 2 is a schematic representation of Procedure A of FIG. 1;

FIG. 3 is a representation of an in-line filter used in Procedure B;

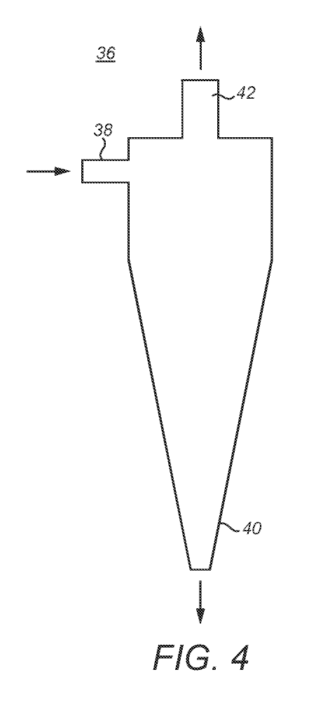

FIG. 4 is a representation of a hydrocyclone;

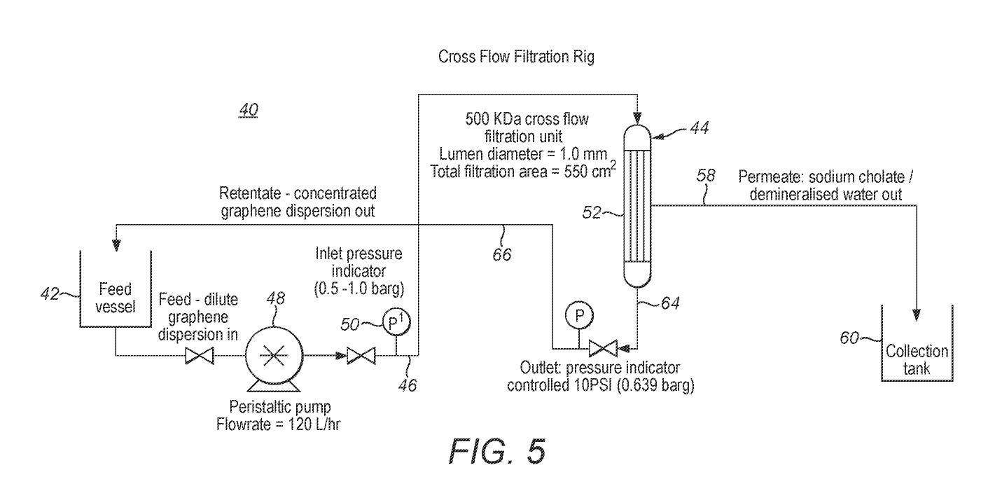

FIG. 5 is a representation of a cross-flow filtration assembly;

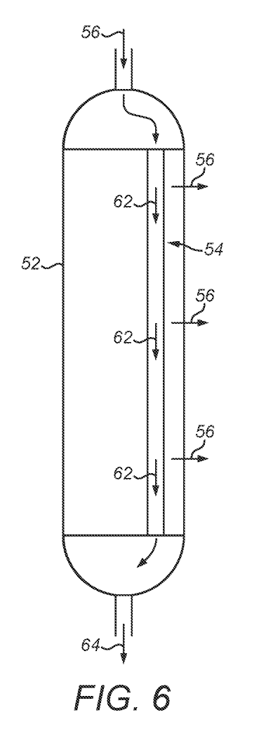

FIG. 6 is a schematic representation of a cross-flow filtration unit;

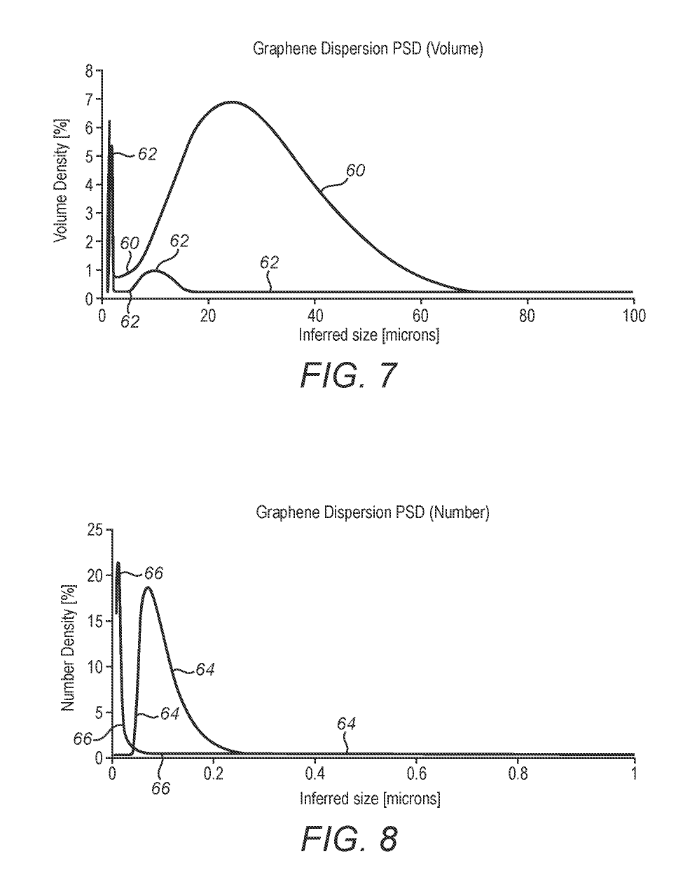

FIG. 7 is a graph illustrating particle sizes, on a particle volume basis, within the graphene dispersion before and after Procedure D;

FIG. 8 is a graph illustrating particle sizes, on a particle number basis, within the graphene dispersion before and after Procedure D;

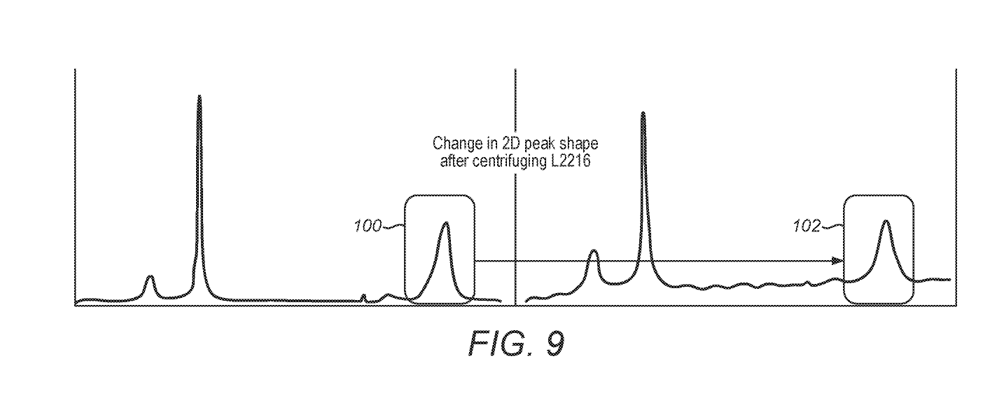

FIG. 9 includes Raman traces of the graphene dispersion before and after Procedure D;

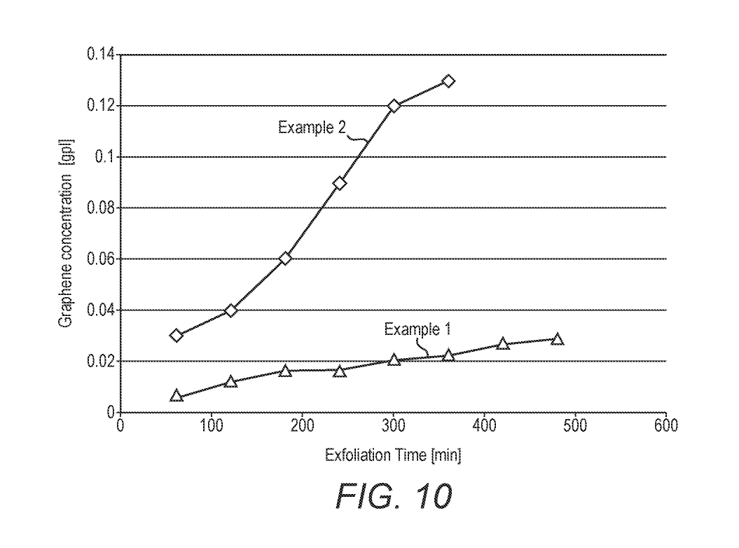

FIG. 10 is a graph of graphene concentration v. exfoliation time for different starting graphite concentrations; and

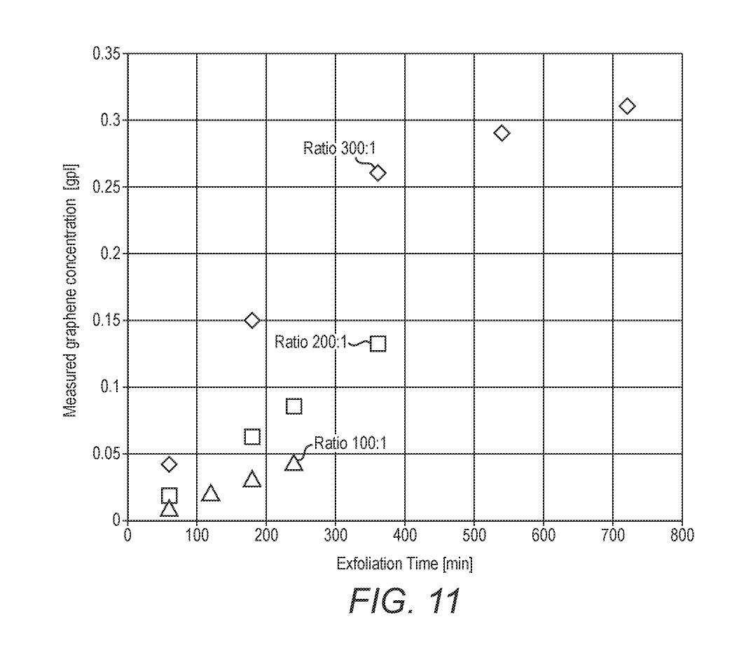

FIG. 11 is a graph of graphene concentration v. exfoliation time for different graphite:surfactant ratios.

The following are referred to hereinafter:

Graphite (A)—a commercially available graphite having a D₅₀ by volume, as measured by Malvern Mastersizer, of 18 μm.

Graphite (B)—a flake graphite with a mean size greater than 100 μm, as measured by sieve analysis.

A process for producing graphene from graphite is illustrated generally in FIG. 1. Referring to the figure, the following procedures are undertaken.

Procedure A—Graphite is selected and exfoliated in an aqueous medium in the presence of surfactant to produce a liquid mixture comprising graphene, graphite, water, surfactant and other contaminants which is fed into Procedure B.

Procedure B—the liquid mixture of Procedure A is treated to remove bulk graphite which is recycled and re-treated in Procedure A. Liquid from Procedure B is then fed into Procedure C.

Procedure C—the liquid mixture of Procedure B is treated to reduce the level of surfactant and produce a liquid which has a higher concentration of graphene. This is then fed into Procedure D.

Procedure D—the liquid containing graphene is subjected to a “polishing” step to remove graphite from the liquid which is recycled back into Procedure A.

Procedure E—the product of Procedure D is tested to assess its characteristics, properties and purity.

Features of the process are described in more detail below.

Referring to FIG. 2, in Procedure A, a 50 litres tank 10 is charged with graphite (3.5 kg, 100 g/l), surfactant (sodium cholate) (35 g, 1 g/l) and water (35 litres). Slurry from tank 10 is pumped into an inline rotor/stator shear mixer 12 which is arranged to impart a shear stress to the slurry. Provided the local shear rate imparted on the slurry exceeds 10000 s⁻¹, the graphite can be efficiently exfoliated to form graphene sheets. The mixture may suitably have a flow rate of 6000 l/hr, a rotation rate of 3000 rpm and a shear rate over 45000 s⁻¹. Batches of slurry may be processed as described over a four hour period. The mixer has several effects—mixing of surfactant with graphite, exfoliating the graphene from the graphite, facilitating recirculation back to tank 10 and pumping material into Procedure B.

The typical yield at the end of the procedure is 2.5-3.5 g of graphene per batch per 3.5 kg of initially charged graphite. This equates to a yield of 0.07-0.10 wt %. The product of Procedure A (comprising 2.5-3-5 g graphene, approx. 3497 g graphite, surfactant and water) is fed into Procedure B.

The aim of procedure B is to separate out the majority of the graphite (or boron nitride) flakes from the dispersion produced in Procedure A so the graphite (or boron nitride) flakes can be recycled back into Procedure A and exfoliated and a dispersion comprising graphene and residual graphite (or boron nitride flakes and powder) can move on to downstream washing and concentration steps.

Procedure B comprises a two stage separation process which includes inline filtration 20 (FIG. 1) and use of hydrocyclone technology 22.

An inline-filtration device 22 is shown diagrammatically in FIG. 3. It may suitably be a Russel Finex Filtration Unit. The device includes a body 24 which houses a removable cylindrical filtration cartridge 26. An auger (not shown) is positioned within the cartridge 26 and is arranged to rotate above axis 28, driven by a motor 30. During rotation, the helical blade-like periphery of the auger contacts the internal cylindrical surface of the cartridge 26 thereby to dislodge solids from it. The solids are then directed by the rotating auger to outlet 30 wherein they are removed from the device. In use, the dispersion from Procedure A is introduced into device 22 via inlet 32; it passes within cartridge 26; solids which are too large to pass through the filtration mesh of the cartridge are retained within the cartridge for subsequent removal by the rotating auger; and filtrate passes through the filtration mesh, as represented by arrows 34, and then passes through outlet 36. In one embodiment the mesh may be a 100 μm mesh.

From outlet 36, the filtrate is introduced into a hydrocyclone 36 represented in FIG. 4. The hydrocyclone 36 includes an inlet 38 for the filtrate from the device 22. The filtrate is fed in under pressure and, by virtue of the high centrifugal forces, solids of sizes generally higher than a predetermined size are directed towards outlet 40 and solids of smaller sizes are directed towards outlet 42. Solids from outlet 40 may be recirculated back to Procedure A. Solids (and associated fluid) from outlet 42 are directed into Procedure C. The hydrocyclone used may suitably have a D₅₀ cut size selected in the range 3 to 10 μm.

The fluid which is directed into Procedure C may contain graphene, graphite, surfactant and water. Objectives of Procedure C are to remove water and thereby increase the concentration of graphene in the water which remains, and also to minimize the concentration of surfactant. No removal of graphite takes place at this stage.

It is believed the surfactant is either:
(i) physisorbed onto the graphene flakes, held on by weak Van der Waal's forces and imparting a charge to the graphene. As a result there is a repulsive force between individual flakes which keeps them in dispersion; or
(ii) the surfactant forms micelles with individual graphene flakes at the centre, again keeping them in dispersion.

Zeta potential of a graphene nanoplatelets has been measured and the results are as follows:
The Zeta Potential of Graphene Nanoplatelets in a 1 g/litre sodium cholate solution is −38.47 mV
The Zeta Potential of Graphene Nanoplatelets diluted in de-ionized water is −17.55 mV.

This points to mechanism (i) dominating—ie the surfactant is weakly physisorbed on the surface and dilution in water allows the sodium cholate to desorb into the bulk.

If left unwashed, the presence of surfactant will cause an unacceptably high sheet resistance in subsequently produced graphene films. This is believed to be caused by the interaction between the surfactant and the electron layer within the graphene sheets. This is illustrated in the table below:

| | | Estimated | | Measured |
|---|---|---|---|---|
| | Graphene | surfactant | | resistance |
| Surfactant | Concen- | concentration | Viscosity | [kOhm/ |
| Level | tration (g/L) | [g/L] | [cP] | 5 mm spot] |
| Low surfactant | 1.1 | 2.2-2.3 | 2 | 20 |
| High surfactant | 1.7 | 17-25.5 | 2 | >>1000 |

It is extremely difficult to maximize the concentration of graphene and minimize the level of surfactant. For example, typical approaches which involve evaporating off the water to concentrate the graphene will leave an even higher concentration of surfactant associated with the graphene. In addition, it should be appreciated that graphene is present as platelets (i.e. particles which are very thin but have a surface area, length and width many times greater than the thickness). For example, graphene flakes may have lengths up to 1000 μm and thicknesses as small as sub-nanometer to a few nanometers.

In Procedure C, a cross-flow filtration assembly 40 is used as illustrated in FIG. 5. The assembly 40 comprises a feed vessel 42 which initially receives the relatively dilute, surfactant-containing, graphene fluid from Procedure B.

The vessel 42 is connected to a cross-flow filtration device 44 via pipe 46 with which a peristaltic pump 48, having a flow rate rating of 120 litres/hour, is associated. An inlet pressure indicator 50 measures the pressure of fluid in the pipe 46. This is typically 2-3 barg. The system can be protected from overpressure by the use of a pressure switch or other relief device. The functioning of the device 44 is illustrated in FIG. 6. The unit comprises a body 52 in which many porous conduits 54 (only one of which is shown in FIG. 6 in the interests of clarity) are arranged. The conduits have a porous cylindrical wall with a 500 kDa pore size. In use, fluid from feed vessel 42 is introduced into the device 44 via inlet 56, at a pressure in the range 2-3 barg. By selection of a suitable pump with a variable speed drive, the same feed tank and pipework can be used to service multiple filter units, therefore increasing processing rates. The pressure on the permeate side of the porous cylindrical wall is ambient pressure although, in some cases, it could be pressurized. Thus, the pressure across the porous cylindrical wall, which serves to drive permeate through the wall, is 2-3 barg. From inlet 56, the fluid passes into the interior of conduits 54. As the fluid is forced, under pressure, through conduits 54, water containing associated surfactant passes through the pores as illustrated by arrows 56. Thus filtrate is led way from the unit 52 via a pipe 58 (FIG. 5) into a collection tank 60. Fluid containing graphene, which is too large to pass through the pores, passes down the conduit 54, as illustrated by arrows 62, and subsequently passes from unit 52 via outlet 64. By virtue of preferential removal of surfactant from the fluid, the concentration of surfactant relative to the concentration of graphene in the fluid which passes from unit 52 via outlet 64, is less than the concentration of surfactant in the fluid introduced into the device 44 via inlet 56. Fluid from outlet 64 can be recirculated, via pipe 66, as often as desired. Typically, it is recirculated twice per batch. Demineralised water may be added to vessel 42 to facilitate further removal of surfactant by device 44. Typically, the process uses 20 to 25 litres of demineralised water to wash 20 to 25 litres of graphene dispersion.

Thus, the device 44 is essentially operated in two modes:
(i) a concentration step, whereby the graphene fluid from Procedure B is concentrated up by removal of permeates, aiming for a concentration of 1 g/L of graphene.
(ii) a wash step in which the concentrated aqueous graphene dispersion is then mixed with fresh demineralised water and re-introduced into unit 52 and filtered. The procedure may be repeated until the conductivity of the permeate (i.e. the aqueous graphene dispersion passing through outlet 64) is below 5 micro S/cm measured using a standard conductivity meter at 20° C.

The performance of the unit 52 is monitored periodically by measuring the permeate flux. This gives an indication of the filtration rate per unit are of filtration membranes of the porous conduits 54. In general terms, it is found that permeate flux (i.e. filtration rate) starts off high, but decays with time to a reasonably steady state value of about 20 l/m² hr. To offset this, the unit 52 may be operated for four days prior to regeneration of the conduits 54. Regeneration may involve flushing the conduits with a dilute caustic solution. The performance can be further improved by restricting the permeate flow from the permeate line by the use of a suitable restrictor valve, (thereby maintaining a steady flux.

Advantageously, device 44 can be used to increase the graphene concentration by ten times or more compared to the concentration of graphene in fluid at the end of Procedure B. Furthermore, the concentration of surfactant in the fluid at the end of Procedure C may be up to thirty times less than in fluid at the end of Procedure B.

Important parameters of device 44 are the circulation rate of fluid introduced and the pressure across the filtration membrane (i.e. the porous cylindrical wall). The circulation rate is set by the pump speed and must be high enough to prevent settling out in the conduits 54 but not too low so as to avoid fouling of the conduits due to settling of solids on surfaces of the conduits. It is desirable for the pressure across the membrane to be high, (within the limits of the filter and pipework design conditions); thereby to maximize the driving force to permeate removal. A variable speed drive can be used to set the pump speed and a pressure switch can be used to avoid over-pressurising the lines.

The concentrated aqueous graphene dispersion of Procedure C (e.g. having a conductivity in the range 3-5 micro S/cm) is next introduced into Procedure D which has the objective of removing as much residual graphite from the graphene dispersion as possible.

It is found that Procedures A to C can be used to produce a graphene dispersion in which about 99.9 wt % of the graphite has been removed. Typically, the dispersion includes 2 pbw graphene and 2 pbw graphite.

In Procedure D, a polishing step is undertaken which comprises centrifuging the graphene dispersion. The centrifugation step has a significant impact on the particle size distribution of the graphene dispersion as illustrated in FIGS. 7 and 8. As seen from FIG. 7, the volume distribution before centrifuging (represented by line 60) is significantly greater than after centrifugation (represented by line 62). Similarly, referring to FIG. 8, the particle size distribution on a number basis 64 is significantly greater before centrifugation than after (represented by line 66). In general terms, it is found that centrifuging for longer at high velocity results in production of smaller graphene nanoplatelets with fewer layers as larger nanoplatelets are lost in the centrifugal sludge At lower centrifuge velocities, there are reduced losses of platelets but there is greater potential for graphite to break through into the final product.

FIG. 9 is a comparison of the Raman traces of the graphene dispersion before Procedure D and the product after Procedure D. The most important features of the Raman spectra are the D band at about 1300 cm⁻¹ and the G band at about 1600 cm⁻¹. The bands are associated with defects and graphitic carbon respectively. The ratio of D to G band intensities is a measure of defect content. Referring to FIG. 9, the 2D peak before Procedure D, referenced 100, shows a “jagged” shape indicating multi-layered material (i.e. graphite) is present. The 2D peak after centrifugation, referenced 102, is more rounded which is consistent with graphene nanoplatelets of about 5-7 layers.

In a preferred embodiment, after procedure D the D/G ratio is 0.05 or below and graphite is not detected by Raman Spectroscopy.

The table below summarises characteristics of the process and products at various stages referred to in FIG. 1.

| Stage | Details |
|---|---|
| Procedure A | Reagents introduced into tank 10: |
| | graphite (3.5 kg) |
| | water (35 L) |
| | sodium cholate (35 g) |
| | this equates to: 100 g/L graphite |
| | 1 g/L sodium cholate |
| | the graphite contains less than |
| | 0.1 wt % inorganic residues in |
| | bulk phase. |
| After Procedure A | Fluid includes: |
| and before | 99 g/L graphite |
| Procedure B | 0.07 g/L graphene |
| | 1 g/L sodium cholate |
| | Bulk conductivity of fluid is |
| | 150-200 μS/cm |
| After Procedure B | Fluid includes: |
| | 0.1-0.2 g/L graphite |
| | 0.07 g/L graphene |
| | 1 g/L sodium cholate |
| | Bulk conductivity of fluid is |
| | 150-200 μS/cm |
| | About 25 L of fluid is fed into |
| | Procedure C. |
| During Procedure C | Uses 25 L of water to “wash” |
| | the material concentrate fluid in |
| | the process by factor of about 25 - |
| | i.e. 25 L from Procedure B is |
| | concentrated up to about 1 L. |
| After Procedure C | Fluid includes: |
| | 2.5-5 g/L graphite |
| | 1.75 g/L graphene |
| | 0.04 g/L sodium cholate |
| | Bulk conductivity of fluid is |
| | 3-5 μS/cm |
| | Approximately 1 L of fluid |
| | obtained at this stage. |
| After Procedure D | D/G ratio determined by Raman |
| | Spectroscopy. It was deemed to be |
| | a “pass” on the basis that its D/G |
| | was 0.5 or below. |
| | Fluid includes: |
| | 1.75 g/L graphene |
| | 0.04 g/L sodium cholate |
| | 2-5 wt % inorganic residues |
| | Bulk conductivity of fluid is |
| | 3-5 μS/cm |

Features of the process described were further assessed and/or modified as described in the following examples.

### EXAMPLE 1—ESTABLISHING BASE-LINE EXFOLIATING CONDITIONS

Procedure A was undertaken using the following features (i.e. reagents/conditions):

| General Feature | Specifics |
|---|---|
| Graphite type | Graphite (A) |
| Mass of graphite | 3.5 kg (100g/L graphite) |
| Mass of sodium cholate | 35 g (1g/L surfactant) |
| Volume of water added | 35 L |
| Total exfoliation time | 8 hours |

The product was sampled every 30 minutes, centrifuged (speed 1500 rpm, 75 minutes. RCF: 500 g) to remove graphite flakes and graphene concentration analysed by UV spectrometry at 600 nm. Results are provided in the table below.

| Exfoliation time (mins) | Graphene concentration (g/L) |
|---|---|
| 60 | 0.0066 |
| 120 | 0.012 |
| 180 | 0.017 |
| 240 | 0.017 |
| 300 | 0.021 |
| 360 | 0.022 |
| 420 | 0.027 |
| 480 | 0.029 |

### EXAMPLE 2—ADJUSTING STARTING GRAPHITE CONCENTRATION

Compared to Example 1, the concentration of graphite in the fluid subjected to exfoliation was doubled, whilst maintaining the same concentration of sodium cholate surfactant. As a result, the ratio of wt % of graphite to surfactant is double compared to that in Example 1. The process undertaken had the following features:

| General Feature | Specifics |
|---|---|
| Graphite type | Graphite (A) |
| Mass of graphite | 7.0 Kg (200 g/L graphite) |
| Mass of sodium cholate | 35 g (1g/L surfactant) |
| Volume of water added | 35 L |
| Total exfoliation time | 6 hours |

The product was sampled and assessed as described in Example 1 and results are provided in the table below.

| Exfoliation time (mins) | Graphene concentration (g/L) |
|---|---|
| 60 | 0.03 |
| 120 | 0.04 |
| 180 | 0.06 |
| 240 | 0.09 |
| 300 | 0.12 |
| 360 | 0.13 |

FIG. 10 summarizes the results of Examples 1 and 2 from which the increased graphene concentration produced is clearly illustrated. This is particularly advantageous since increased graphene concentration is achieved using a higher graphite:surfactant ratio which is desirable since purification of the final produce may be facilitated and/or surfactant concentration in the final graphene product may be reduced.

### EXAMPLE 3—ADJUSTING SURFACTANT LEVEL USED IN EXFOLIATION TO 400:1 (GRAPHITE:SURFACTANT)

The mass of surfactant used in the Example 1 process was varied so the ratio of the wt % of graphite to the wt % of surfactant was 400:1. The yield after 4 hours was only 0.005 g/L graphene which is significantly inferior to that achieved using a ratio of 100:1 (Example 1) or 200:1 (Example 2).

### EXAMPLE 4—COMPARISON OF EFFECTIVENESS OF EXFOLIATION AT DIFFERENT RATIOS OF GRAPHITE TO SURFACTANT

The mass of surfactant used in Example 1 was varied so the ratio of the wt % of graphite to the wt % of surfactant was 300:1. Results are produced in FIG. 11 which also includes a comparison with ratios of 100:1 and 200:1. Thus, there appears to be a “sweet spot”. It will be appreciated that increasing the amount of surfactant does not necessarily increase the amount of graphene exfoliated from graphite; and reducing the amount of surfactant eventually leads to a very significant fall off in the amount of graphene produced.

### EXAMPLE 5—EXFOLIATION AT 1000 L SCALE—BASE LINE CONDITIONS

Procedure A was undertaken using the following features (i.e. reagents/conditions):

| General Feature | Specifics |
|---|---|
| Graphite type | Graphite (A) |
| Mass of graphite | 75 kg (100 g/L graphite) |
| Mass of sodium cholate | 750 g (1 g/L surfactant) |
| Volume of water added | 750 L |
| Total exfoliation time | 6 hours |

The product was sampled every 60 minutes, centrifuged (speed 1500 rpm, 75 minutes. RCF: 500 g) to remove graphite flakes and graphene concentration analysed by UV spectrometry at 600 nm. Results are provided in the table below.

| Exfoliation time (mins) | Graphene concentration (g/L) |
|---|---|
| 60 | 0.015 |
| 120 | 0.029 |
| 180 | 0.04 |
| 240 | 0.056 |
| 300 | 0.074 |
| 360 | 0.083 |

The table above shows how the graphene exfoliation process can be scaled up from 50 L to 1000 L.

### EXAMPLE 6—EXFOLIATION AT 1000 L SCALE—ADJUSTING STARTING GRAPHITE CONCENTRATION

Procedure A was undertaken using the following features (i.e. reagents/conditions):

| General Feature | Specifics |
|---|---|
| Graphite type | Graphite (A) |
| Mass of graphite | 150 Kg (200 g/L graphite) |
| Mass of sodium cholate | 750 g (1 g/L surfactant) |
| Volume of water added | 750 L |
| Total exfoliation time | 6 hours |

The product was sampled every 60 minutes, centrifuged (speed 1500 rpm, 75 minutes. RCF: 500 g) to remove graphite flakes and graphene concentration analysed by UV spectrometry at 600 nm. Results are provided in the table below.

| Exfoliation time (mins) | Graphene concentration (g/L) |
|---|---|
| 60 | 0.03 |
| 120 | 0.05 |
| 180 | 0.06 |
| 240 | 0.09 |
| 300 | 0.1 |
| 360 | 0.12 |

The product was sampled every 60 minutes, centrifuged (speed 1500 rpm, 75 minutes. RCF: 500 g) to remove graphite flakes and graphene concentration analysed by UV spectrometry at 600 nm. Results are provided in the table below.

The above table shows how increasing the graphite yield gives an increase in graphene yield.

### EXAMPLE 7—EXFOLIATION AT 1000 L SCALE—USE OF SODIUM DODECYLBENZENESULPHONATE (SDBS) AS A SURFACTANT

Procedure A was undertaken using the following features (i.e. reagents/conditions):

| General Feature | Specifics |
|---|---|
| Graphite type | Graphite (A) |
| Mass of graphite | 225 Kg (300 g/L graphite) |
| Mass of sodium | 750 g (1 g/L surfactant) |
| dodecylbenzenesulphonate | |
| Volume of water added | 750 L |
| Total exfoliation time | 12 hours |

The product was sampled every 60 minutes, centrifuged (speed 1500 rpm, 75 minutes. RCF: 500 g) to remove graphite flakes and graphene concentration analysed by UV spectrometry at 600 nm. Results are provided in the table below.

| Exfoliation time (mins) | Graphene concentration (g/L) |
|---|---|
| 60 | 0.102 |
| 120 | 0.149 |
| 180 | 0.194 |
| 240 | 0.229 |
| 300 | 0.252 |
| 360 | 0.285 |
| 420 | 0.308 |
| 480 | 0.357 |
| 540 | 0.378 |
| 600 | 0.386 |
| 660 | 0.409 |
| 720 | 0.417 |

The table shows that:
1. SDBS is a viable surfactant. The material formed in Procedure A was successfully processed through Procedures B, C and E;
2. Increasing the starting graphite concentration gives an improvement in yield for a given time;
3. Increasing the production time gives an improvement in yield.

### EXAMPLE 8—ABILITY TO DESTABILISE USING SULPHURIC ACID

A batch of concentrated dispersion produced according to Example 5, was “destabilised” by the addition of 0.225 g of concentrated sulphuric acid per litre of dispersion. This yielded 132 g of graphene nanoplatelet powder that was filtered in demineralised water and washed in acetone, subsequent to drying to yield a dryer graphene powder.

### EXAMPLE 9—BORON NITRIDE EXFOLIATION AND SEPARATION IN THE 50 L REACTOR

| General Feature | Specifics |
|---|---|
| Boron Nitride Type | Hexagonal Boron Nitride -particle = 100 micron |
| Mass of graphite | 1 kg (28.6 g/L Boron Nitride) |
| Mass of sodium cholate | 35 g (1 g/L surfactant) |
| Volume of water added | 35 L |
| Total exfoliation time | 6 hours |

After exfoliation, the mixture was allowed to settle in the 50 L reactor. Approx 20 L of supernatant was extracted and allowed to settle for approximately 4 weeks. The samples were analysed using a Malvern Mastersizer and it was found that by both centrifugation and settling, the amount of larger flakes was reduced, leading to a dispersion that mainly consists of nanoplatelets.

Upon drying down the 20 L of supernatant, approximately 20 g of solid boron nitride nanoplatelets was obtained. This was a surprising result as the yield was almost 10 times higher than for graphene exfoliated from graphite, especially at a lower feed material loading. This suggests that BN exfoliates more readily than graphite, possibly due to weaker forces in between layers. Thus, the graphene production route described in FIG. 1 can also be used for BN production.

1. A method of preparing a 2D material, the method comprising:
(i) selecting a fluid comprising a 2D material dispersed in a solvent;
(ii) using a filtration device to remove solvent from the fluid and increase the concentration of 2D material in the fluid;
wherein said filtration device comprises an inlet for passage of fluid into the filtration device and an outlet for passage of unfiltered fluid away from the filtration device, wherein a filtration surface is positioned between the inlet and outlet and the filtration device is arranged to direct fluid tangentially or parallel to the filtration surface.

2. A method according to claim 1, wherein said 2D material has, on average, fewer than 10 layers; and said fluid selected in step (i) includes graphene or boron nitride.

3-36. (canceled)

37. A method according to claim 1 wherein said device includes a conduit for passage of filtrate away from the filtration surface and said filtration surface is arranged so that at least 80 wt % of said 2D material included in said fluid selected in step (i) does not pass through said filtration surface.

38. A method according to claim 1, wherein said filtration surface has a pore size of less than 1000 kDa; and preferably at least 200 kDa.

39. A method according to claim 38, wherein said filtration device includes an elongate conduit having an inlet and outlet, wherein a wall of the conduit defines said filtration surface; and a lumen defined by said wall has a diameter of at least 0.1 mm; and the diameter is less than 2 mm.

40. A method according to claim 1, wherein the pressure of fluid at the inlet of the filtration device is in the range 200,000 to 300,000 Pa and the pressure across the filtration surface of the device is in the range 50,000 to 200,000 Pa.

41. A method according to claim 1, wherein the rate of flow of fluid comprising said 2D material dispersed in said solvent into the filtration device is greater than 300 litres/hour.

42. A method according to claim 1, wherein said fluid selected in step (i) includes a surfactant, wherein said surfactant has a solubility of at least 10 g/L; and/or a molecular weight of less than 800 g/mol.

43. A method according to claim 1, wherein said solvent is water.

44. A method according to claim 1, wherein said fluid selected in step (i) includes at least 0.02 g/L of said 2D material and it includes less than 2 g/L of said surfactant.

45. A method according to claim 44, wherein said fluid selected in step (i) has a bulk conductivity at 20° C. of at least 50 μS/cm; and/or the conductivity is less than 350 μS/cm.

46. A method according to claim 1, wherein, in said fluid selected in step (i), the ratio of the concentration of 2D material divided by the concentration of surfactant is in the range 0.025 to 2.

47. A method according to claim 1, wherein, during the method, the ratio of the concentration of 2D material in the unfiltered fluid at said outlet divided by the concentration of 2D material selected in step (i) is at least 10.

48. A method according to claim 1, wherein the method includes a wash step wherein unfiltered fluid from said outlet is diluted with additional solvent and the diluted unfiltered fluid is reintroduced into the filtration device via its inlet.

49. A method according to claim 1, wherein the ratio of the concentration of surfactant at the beginning of the method divided by the concentration of surfactant in the unfiltered fluid in said outlet, is at least 15.

50. A method according to claim 1, wherein, prior to step (i), the method includes a step (A) which comprises selecting a 3D material and treating the 3D material to exfoliate it and produce said 2D material, wherein step (A) comprises selecting a liquid formulation (A) comprising said 3D material, a surfactant and said solvent; wherein a liquid formulation (B) produced after exfoliation in step (A) is treated in a step (B) to remove the 3D material from liquid formulation (B) and increase the concentration of 2D material relative to 3D material, wherein treatment of liquid formulation (B) in step (B) comprises use of a hydrocyclone.

51. A method according to claim 50, wherein liquid formulation (A) includes 2000 to 4000 parts by weight (pbw) 3D material, 20000 to 40000 pbw of solvent which is water and 10 to 100 pbw of said surfactant.

52. A method according to claim 1, wherein said 2D material has, on average, fewer than 10 layers and is selected from the group comprising graphene and boron nitride;
wherein said device includes a conduit for passage of filtrate away from the filtration surface and said filtration surface is arranged so that at least 80 wt % of said 2D material included in said fluid selected in step (i) does not pass through said filtration surface;
wherein said filtration surface has a pore size of less than 1000 kDa; and at least 200 kDa;
wherein said filtration device includes an elongate conduit having an inlet and outlet wherein a wall of the conduit defines said filtration surface; and a lumen defined by said wall has a diameter of at least 0.1 mm;
wherein the pressure of fluid at the inlet of the filtration device is in the range 200,000 to 300,000 Pa and the pressure across the filtration surface of the device is in the range 50,000 to 200,000 Pa.

53. A method according to claim 1, wherein said fluid selected in step (i) includes graphene or boron nitride;
wherein said fluid selected in step (i) includes a surfactant;
wherein said solvent is water;
wherein said fluid selected in step (i) includes at least 0.02 g/L of said 2D material;
wherein said fluid selected in step (i) includes at least 0.2 g/L of said surfactant;
wherein said fluid selected in step (i) has a bulk conductivity at 20° C. of at least 50 μS/cm and less than 350 μS/cm;
wherein, in said fluid selected in step (i), the ratio of the concentration of 2D material divided by the concentration of surfactant is in the range 0.025 to 2;
wherein, after step (ii), the concentration of surfactant in said solvent is less than 0.5 g/L.

54. A method of increasing the concentration of 2D material in a fluid, said 2D material being selected from the group comprising graphene and boron nitride, the method comprising:
(i) selecting a fluid comprising a 2D material dispersed in a solvent;
(ii) using a filtration device to remove solvent from the fluid and increase the concentration of 2D material in the fluid;
wherein said filtration device comprises an inlet for passage of fluid into the filtration device and an outlet for passage of unfiltered fluid away from the filtration device, wherein a filtration surface is positioned between the inlet and outlet and the filtration device is arranged to direct fluid tangentially or parallel to the filtration surface.
